(19) United States
(12) Patent Application Publication
(10) Pub. No.: US 2003/0236669 A1
(43) Pub. Date: Dec. 25, 2003

(54) Motor system for use in dental/medical procedures, and related methods

(76) Inventor: Scott Lewallen, Duvall, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/177,559

(22) Filed: Jun. 21, 2002

(51) Int. Cl. G10L 21/00

(52) U.S. Cl. 704/275

(57) ABSTRACT

The present invention provides motor systems that a dental or medical practitioner can quickly prepare for a dental/medical procedure and can quickly modify an operational parameter of a tool connected to the system during a procedure without increasing the risk of contaminating the procedure's sterile environment by speaking commands into a microphone of the system. The motor system can include a motor providing an output for powering a tool connected to the system, a pump that can move irrigating fluid toward or away from a tool, a data input component that can include a microphone that can receive spoken audio voice data, and a processing component that can identify a command in the spoken audio voice data and can modify the output of the motor, pump or both. The processing component can also include a memory for storing motor-output-data that can include a value for any desired motor output parameter, like, speed and direction of rotation, torque and torque threshold. These output parameter values can be combined together and associated with any desired corresponding identifier that is also stored in the memory of the processing component. The data input component can also include buttons a dental or medical practitioner can push and a bar code reader a dental or medical practitioner can scan a bar code with to modify a tool's operational parameter.

### BACKGROUND

Dental and medical practitioners routinely perform dental/medical procedures that typically involve using a tool such as a bur, cutter, reamer, or polisher powered by a motor system that includes a motor to cut a patient's tooth, bone, or soft tissue. To perform these procedures, the dental or medical practitioner first typically prepares the motor system for the procedure. For example, the dental or medical practitioner typically determines the tool and the tool's operational parameters desired for the procedure and then instructs the motor system to accordingly modify the output of the system's motor. Then, during the procedure, the dental or medical practitioner often instructs the motor system to modify an operational parameter of the tool by modifying the output of the system's motor. Unfortunately, preparing the motor system and modifying an operational parameter of a tool during a procedure can be time consuming and can increase the risk of contaminating the procedure's sterile environment.

Preparing the motor system for a procedure and modifying an operational parameter of a tool during a procedure can be time consuming for a number reasons. Determining the operational parameters for a tool often requires the dental or medical practitioner to search for and retrieve the operational parameters from a manual or other source containing the information. This can be very time consuming, especially if more than one operational parameter is to be modified at one time or if different tools requiring different operational parameters are to be used during a procedure. Instructing the motor system often requires physically touching the system, which typically includes locating a correct button on the system and then physically manipulating the button. Consequently, while preparing the motor system, the dental or medical practitioner can waste time locating and manipulating the correct button, and, while modifying an operational parameter of a tool during a procedure, the dental or medical practitioner can waste time moving his/her eyes from the patient and his/her hand from the tool, locating and manipulating the correct button, and then moving his/her eyes and hand back to the patient and tool.

Modifying an operational parameter of a tool during a procedure can also increase the risk of contaminating the procedure's sterile environment because the dental or medical practitioner typically has to physically touch the motor system. Thus, any bacterial or viral contamination located on the motor system can be introduced to the dental or medical practitioner's hand and transported into the procedure's sterile environment.

Thus, there is a need for a motor system that allows a dental or medical practitioner to quickly prepare a motor system for a procedure and modify at least one operational parameter of a tool connected to the system during the procedure. There is also a need for a motor system that a dental or medical practitioner can modify without increasing the risk of contaminating the procedure's sterile environment.

### SUMMARY

In one aspect of the present invention a motor system is provided that a dental or medical practitioner can quickly prepare for a procedure and quickly modify an operational parameter of a tool connected to the motor system during the procedure. The motor system can include a motor providing an output for powering a tool connected to the system and a pump for moving irrigating fluid toward or away from the patient or tool or both. The motor system can also include a data input component that includes a microphone operable to receive spoken audio voice data, and a processing component operable to identify a command in the spoken audio voice data and to modify the output of the motor, pump or both. Thus, a dental or medical practitioner can speak commands to the motor system to prepare the system for a procedure or modify an operational parameter of a tool connected to the motor, pump or both. By speaking commands, the dental or medical practitioner does not have to touch the motor system to modify an operational parameter of the tool. Thus, a dental or medical practitioner can modify an operational parameter of a tool during a procedure without increasing the risk of contaminating the procedure's sterile environment.

To quickly modify the output of the motor, pump or both after attaching a tool different than the previous tool or to quickly modify more than one output parameter of the motor or pump, the processing component can include a memory for storing motor output data that can include at least one value of any desired motor output parameter such as speed and direction of rotation, torque and torque threshold, and pump output data that can include at least one value of any desired pump output parameter such as flow rate, and on or off. These output parameters can be combined together and associated with an identifier that is also stored in the memory of the processing component. For example, a particular tool may require a speed of 300 rpms, a torque of 50 gram-centimeters (g·cm) and may be used with a handpiece that reduces the output speed of the system's motor by a factor of eight. The speed, torque and handpiece ratio can be grouped together and identified with the word “one”. When, the dental or medical practitioner wants to power a tool at the particular speed and torque with a handpiece that reduces the output of the motor by a factor of eight, the dental or medical practitioner can simply say “one”. The processing component then modifies the output speed and torque of the system's motor according to the value for each motor output parameter included in the combination of values that corresponds to the spoken word “one”.

In another aspect of the invention, the data input component can also include a bar code reader operable to read a bar code and the processing component can modify the output of the motor, pump or both according to the bar code data generated from the bar code. The bar code data can include motor output data, pump output data or both, or the bar code data can include an identifier of a combination of values for output parameters of a motor, pump or both stored in memory.

In another aspect of the invention, the data input component can also include at least one button operable to modify the motor system's motor, pump or both. For example, the at least one button can include at least one preset button operable to select a motor-output-parameter value stored in memory. In addition, the at least one button can include at least one of the following buttons: a) two ratio buttons operable to provide the processing component the output ratio of a handpiece, b) a speed button operable to increase a rotational speed of the motor, c) another speed button operable to decrease a rotational speed of the motor, d) a forward/reverse button operable to select a rotational direction of the motor, e) a torque button operable to increase a torque output of the motor, f) another torque button operable to decrease a torque output of the motor, g) a max button operable to select a threshold torque output of the motor, h) a pump button operable to increase a flow rate of the pump, i) another pump button operable to decrease a flow rate of the pump, and j) a pump on/off button operable to turn a pump on and off. Thus, a dental or medical practitioner can prepare the motor system for a procedure and modify an output of the motor, pump or both by pushing an appropriate button.

In another aspect of the invention, an aural sound can sound when the processing component identifies a command in the spoken audio voice data or the bar code reader reads a bar code. For example, the motor system can “beep” when the processing component identifies a command or a bar code is read by a bar-code reader. Or, the motor system can provide any other desired sound when the processing component identifies a command.

In another aspect of the invention, a method for modifying an operational parameter of a tool connected to a motor system is provided. The method can include a) a data input component receiving spoken audio voice data from a dental or medical practitioner, b) a processing component identifying a command in the spoken audio voice data, and c) the processing component modifying an output of a motor operable to power the tool according to the command. The method can also include a) storing at least one combination of values for different motor output parameters of a motor's output, b) identifying a combination of values with a corresponding identifier, c) identifying an identifier in spoken audio voice data, and d) retrieving the combination of values corresponding to the identifier.

### BRIEF DESCRIPTION OF THE FIGURES

FIG. 1 is a perspective view of a motor system according to an embodiment of the invention.

FIG. 2 is a block diagram of the motor system in FIG. 1.

FIG. 3 is a flow chart of a process for preparing the motor system for a dental/medical procedure and operating the motor system during a dental/medical procedure, according to an embodiment of the invention.

FIG. 4 is a perspective view of a motor system according to another embodiment of the invention.

FIG. 5 is a block diagram of the motor system in FIG. 4.

### DETAILED DESCRIPTION

The present invention provides motor systems that a dental or medical practitioner can quickly prepare for a dental/medical procedure, and can quickly modify an operational parameter of a tool connected to the system during a procedure without increasing the risk of contaminating the procedure's sterile environment. The present invention also provides methods for quickly and easily preparing a motor system for a procedure and modifying an operational parameter of a tool during the procedure. For example, a dental or medical practitioner can prepare a motor system or modify an operational parameter of a tool connected to a system by speaking commands into a microphone of the system, by pushing a button of the system or by reading a bar code with a bar code reader of the system. Speaking commands to the system allows the dental or medical practitioner to modify an operational parameter of a tool during a procedure while keeping his hands and eyes focused on the patient and without increasing the risk of contaminating the procedure's sterile environment. Pushing a button of the system allows the dental or medical practitioner to modify an operational parameter of a tool during a procedure without informing the patient of the modification, but typically involves increasing the risk of contaminating the procedure's sterile environment. Reading a bar code allows the dental or medical practitioner to quickly prepare a system for a procedure and modify an operational parameter of a tool but also typically involves increasing the risk of contaminating the procedure's sterile environment.

The motor system can include a motor providing an output for powering a tool connected to the system, a data input component that can include a microphone that can receive spoken audio voice data, and a processing component that can identify a command in the spoken audio voice data and can modify the output of the motor. Thus, a dental or medical practitioner can speak commands to the motor system to prepare the system for a procedure or modify an operational parameter of a tool connected to the motor. In addition, the motor system can include a pump that can move irrigating fluid toward or away from a tool connected to the motor of the system or toward or away from a patient, and the processing component can modify the output of the pump.

The processing component can include a memory for storing motor output data that can include at least one value of any desired motor output parameter, such as, speed and direction of rotation, torque, and torque threshold, to quickly modify the output of the motor after attaching a different tool to the motor or to quickly modify more than one output parameter of the motor. These output parameter values can be combined together and associated with any desired corresponding identifier that is also stored in the memory of the processing component. For example, a particular tool may require a speed of 300 rpms, a torque of 50 gram-centimeters (g·cm) and may be used with a handpiece that reduces the output speed of the system's motor by a factor of eight. The speed, torque and handpiece ratio can be combined together and identified with the word “one”. When, the dental or medical practitioner wants to power a tool at the particular speed and torque with a handpiece that reduces the output of the motor by a factor of eight, the dental or medical practitioner can simply say “one”. The processing component then modifies the output speed and torque of the system's motor according to the value for each motor output parameter included in the combination of values that corresponds to the spoken words “one”. Thus, the process of modifying more than one output parameter of a motor's output can be quick.

The scope of the present invention includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim.

All terms used herein, including those specifically described below in this section, are used in accordance with their ordinary meaning unless the context or definition indicates otherwise. Also unless indicated otherwise, except within the claims, the use of “or” includes “and” and vice-versa. Non-limiting terms are not to be construed as limiting unless expressly stated (for example, “including” and “comprising” mean “including without limitation” unless expressly stated otherwise).

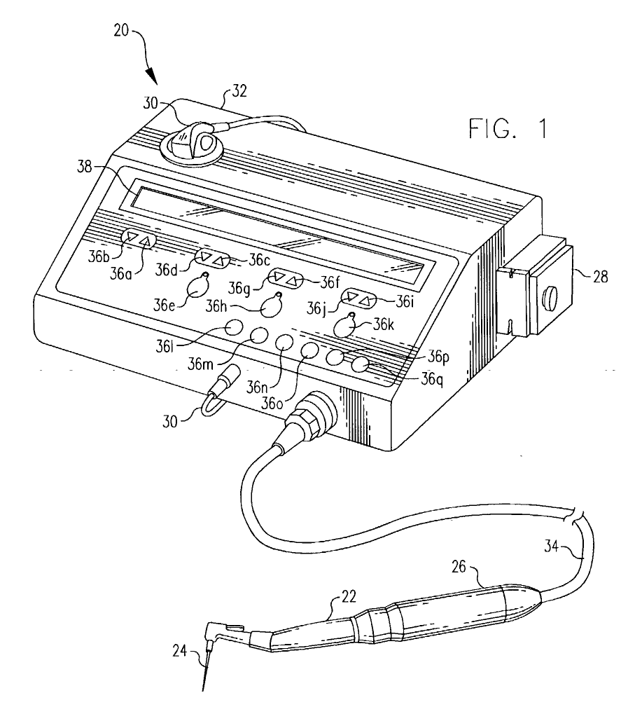

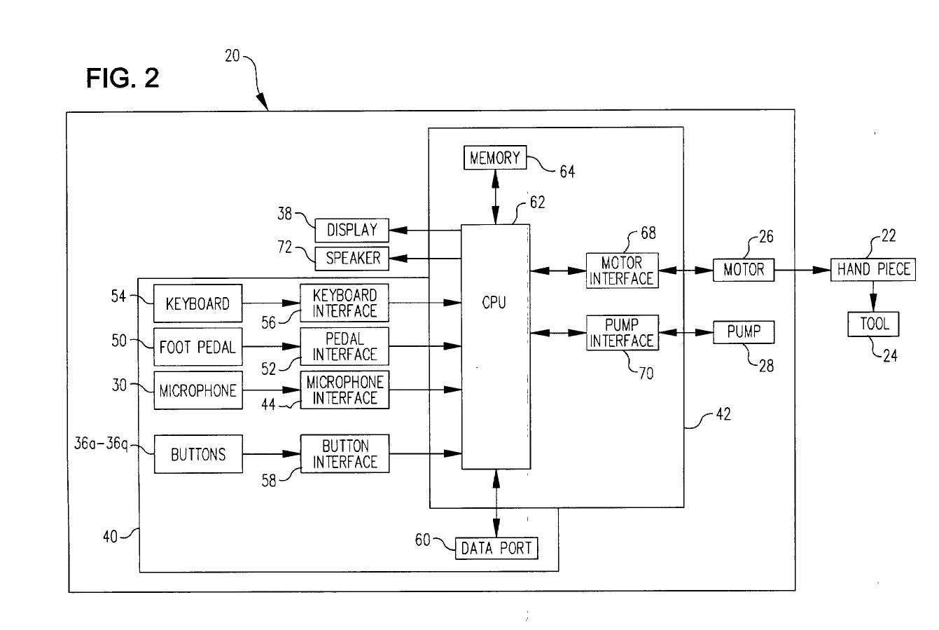

FIG. 1 is a perspective view of a motor system 20 according to an embodiment of the invention. The motor system 20 is shown in FIG. 1 with a hand piece 22 removably connected to the system 20 and a tool 24 removably connected to the hand piece 22. In this and certain other embodiments, the motor system 20 can include a motor 26 that can provide an output and can power the handpiece 22 and tool 24, and a pump 28 for supplying irrigating fluid to the tool 24. The motor system 20 can also include a data input component including a microphone 30 that can receive spoken audio voice data and a processing component (not shown but discussed in greater detail in conjunction with FIG. 2) housed within a body 32 and removably connected to the motor 26 by the cable 34. The processing component can identify a command in the spoken audio voice data and modify the motor's or pump's output according to the command. Thus, a dental or medical practitioner can quickly modify an operational parameter of the tool 24 without having to remove the tool 24 or his/her eyes from a patient's tooth, bone, gum or other soft tissue and without increasing the risk of contaminating the procedure's sterile environment.

Still referring to FIG. 1, the type of procedure performed by the dental or medical practitioner often determines which operational parameter of the tool 24 the dental or medical practitioner may want to control and often determines which type of tool 24 and handpiece 22 the dental or medical practitioner may want to attach to the motor 26. Consequently, the output parameters of the motor 26 and pump 28 that a dental or medical practitioner can modify can be any desired output parameter. For example, if the dental or medical practitioner is performing a pulpotomy—removal of all or a portion of a tooth's pulp—the dental or medical practitioner might use a cutter or reamer. And thus, in this and certain other embodiments, the dental or medical practitioner can modify the speed and torque of the cutter or reamer. Furthermore, the dental or medical practitioner can establish a threshold torque that triggers the processing component to stop the motor 26 or reverse the rotational direction of the motor 26 once the threshold torque is reached. This may be desirable to prevent the cutter or reamer from shearing apart if it enters bone or the tooth's enamel. Or, if the dental or medical practitioner is preparing a jaw to receive a tooth implant, the dental or medical practitioner might use a cutter and a hand piece 22 that includes an irrigation conduit to supply irrigating fluid to the cutter. And thus, in this and certain other embodiments, the dental or medical practitioner can modify the speed and torque of the cutter and the flow rate of the pump 28.

Still referring to FIG. 1, the motor 26 and the pump 28 can be any desired motor and pump capable of respectively powering a desired tool and providing a desired irrigating fluid flow rate. For example, in this and certain other embodiments, the motor 26 can be any desired brushless electric motor capable of providing variable speeds up to approximately 30,000 rpms and can power any type of tool such as a cutter, a grinder, a reamer, a drill, a file and a screwdriver. The pump 32 can be any desired electrical pump such as a positive-displacement reciprocating or rotary pump, a centrifugal or radial-flow pump, or axial-flow pump. Or, in other embodiments, the motor, the pump or both can be pneumatically driven.

Still referring to FIG. 1 in this and certain other embodiments, the handpiece 22 can be any desired hand piece that increases, decreases or leaves substantially unchanged the speed and torque of the motor 26. For example, the hand piece 22 can increase the speed and decrease the torque of a tool 24 by a factor of four, eight, sixteen or sixty-four, or decrease the speed and increase the torque of the tool 24 by a factor of five. Consequently, to accurately modify an operational parameter of the tool 24, the processing component should know the output ratio of the handpiece 22. Thus, in this and certain other embodiments, a dental or medical practitioner can provide the processing component the output ratio of the handpiece 22.

Still referring to FIG. 1 in this and certain other embodiments, the data input component can include buttons 36a-36q that a dental or medical practitioner can push to modify the motor's or pump's output. Thus, the buttons 36a-36q can provide a dental or medical practitioner an additional way of modifying an operational parameter of the tool 24. For example, the buttons 36 can include a) a ratio button 36a for increasing and another ratio button 36b for decreasing the output ratio of the handpiece 22 that the dental or medical practitioner provides the processing component; b) a speed button 36c for increasing and another speed button 36d for decreasing the speed of the motor 26; c) a forward/reverse button 36e for selecting a rotational direction of the motor 26; d) a torque button 36f for increasing and a torque button 36g for decreasing the torque of the motor 26; e) a max button 36h for selecting a threshold torque output of the motor 26; f) a pump button 36i for increasing and another pump button 36j for decreasing the flow rate of the pump 28; and g) a pump on/off button 36k for turning the pump 28 on and off. Using the buttons may be desirable when a dental or medical practitioner is preparing the motor system for a procedure or when the dental or medical practitioner does not want the patient to hear some details of the procedure.

Still referring to FIG. 1, the buttons 36a-36q can include any desired number of preset buttons associated with a value for a motor-output-parameter or for a pump-output-parameter, or with a combination of values for different motor and pump output-parameters stored in the processing component. When pressed, the preset button can modify an output parameter of the motor 26, pump 28 or both according to the identified values stored in the processing component. For example, the data input component can include six preset buttons 36l-36q with one button 36l corresponding to a speed and torque of a particular cutter and another button 36m corresponding to a speed and torque of another particular cutter and a particular flow rate for the pump 28. Thus, a dental or medical practitioner can quickly modify an operational parameter of the tool 24, pump 28 or both by pressing one of the preset buttons 36l-36q.

Still referring to FIG. 1, in this and certain other embodiments, the body 32 can include a display 38 that can display the current operational parameters of the tool 24 and pump 28 or the desired operational parameters to be used. The display 38 can be any desired type of display. For example, the display 38 can be a backlit liquid crystal display. Additionally or alternatively, the display can include an array of lights that can indicate the current or desired operational parameters of the tool 24.

FIG. 2 is a block diagram of the motor system 20 in FIG. 1, according to an embodiment of the invention. The data input component 40 allows a dental or medical practitioner to modify an operational parameter of a tool 24 or pump 28 by providing data that includes a command to the processing component 42. The processing component 42 identifies the command and accordingly modifies an operational parameter of the tool 24 or pump 28.

In this and certain other embodiments, the data input component includes a microphone 30 and microphone interface 44. The microphone 30 receives audio voice data (words or any other desired sounds) spoken by a dental or medical practitioner and sends the audio voice data to the microphone interface 44. The microphone 30 can be any desired microphone capable of performing this function. For example, the microphone 30 can be a conventional all-purpose microphone or the microphone 30 can be a unidirectional microphone. The microphone interface 44 converts the spoken audio data to digital audio voice data and sends the digital audio voice data to the processing component 42.

Still referring to FIG. 2, the data input component 40 can include any other desired types of input devices. For example, the data input component 40 can include a foot pedal 50 and pedal interface 52 for allowing a dental or medical practitioner to provide the processing component 42 data with his/her foot. Additionally or alternatively, the data input device 40 can include a keyboard 54 and keyboard interface 56. Additionally or alternatively, the data input device 40 can include a data port 60 for downloading data or software such as voice recognition software, motor or other device drivers. Additionally or alternatively, and as discussed elsewhere herein, the data input component 40 can include buttons 36a-36q and a button interface 58 for converting the displacement of any of the buttons 36a-36q into digital data for the processing component 42. Additionally or alternatively, the data input component can include a tool-card caddy (not shown) that can include a card (not shown) representing a command and placed in a caddy (not shown) and the caddy can include an optical switch to determine whether the card is in the caddy-or not. To provide the processing component 42 with data, the dental or medical practitioner removes the appropriate card representing his/her desired command from the caddy.

Still referring to FIG. 2, in this and certain other embodiments, the processing component 42 can include a central processing unit (CPU) 62 and memory 64 for performing functions such as executing software to perform tasks. For example, when the CPU 62 receives digital audio data from the microphone interface 44, the CPU identifies any command included in the data and accordingly modifies an operational parameter of the tool 24 by modifying a motor-output-parameter of the motor's output via the motor interface 68, or accordingly modifies a pump-output-parameter of the pump's output via the pump interface 70. Likewise, when the CPU 62 receives digital data from the button interface 58 or other data input component interfaces 52 and 56, the CPU 62 identifies any command included in the data and accordingly modifies a motor-output-parameter or a pump-output-parameter. The motor interface 68 and pump interface 70 convert the output-parameter modifications from the CPU 62 in digital form to analog form that the motor 26 and pump 28, respectively, can respond to.

Still referring to FIG. 2 in this and certain other embodiments, the memory 64 can store motor-output-data that includes at least one value for a motor-output-parameter and pump-output-data that includes at least one value for a pump-output-parameter. These values can be stored and each value individually associated with a corresponding identifier or these values can be combined as desired and each combination can be associated with a corresponding identifier. Furthermore, the identifiers associated with either an individual value or a combination of values can be any desired identifier. For example, a dental or medical practitioner can combine particular values, suggested by a manufacturer of a tool 24, for a speed and a torque motor-output-parameter and identify the combination as the make and model of the tool 24 the combination is used with. Additionally or alternatively, a dental or medical practitioner can combine particular desired values for a speed and a torque motor-output-parameter with a particular value for a flow rate pump-output-parameter and identify the combination as “one”. Additionally or alternatively, a dental or medical practitioner can identify a particular value for a speed motor-output-parameter and identify the value as “preset two”. Then when the dental or medical practitioner wants to prepare the motor system 20 or modify an operational parameter of a tool 24 or the output of the pump 28, the dental or medical practitioner can say the identifier into the microphone 30 or push at least one of the preset buttons 36l-36q. Thus, a dental or medical practitioner can quickly prepare a motor system for a procedure and can quickly modify one or more operational parameters of a tool 24 or pump 28 during a procedure.

Still referring to FIG. 2, the memory 64 can be fixed to the processing component 42, removably attachable to the processing component 42, or can include a portion that is fixed and another portion that is removably attachable to the processing component 42. For example, the memory 64 can include any desired removable storage media such as a floppy disc, compact disc, magnetic tape or removable hard drive that can store motor-output-data, pump-output-data, corresponding identifiers (as discussed elsewhere herein) and instructions to correspond at least one of the buttons 36l-36q with motor-output-data, pump-output-data or both. This may be desirable to help reduce the time a dental or medical practitioner spends programming buttons 36l-36q or to allow a dental or medical practitioner to store more motor-output-data, pump-output-data and corresponding identifiers.

Still referring to FIG. 2, the CPU 62 can also notify a dental or medical practitioner in any desired manner when the CPU 62 identifies a command in the data received from the data input component 40. For example, in this and certain other embodiments when the CPU 62 identifies a command in the spoken audio voice data, the CPU 62 can provide a “beep” via a speaker 72. This may be desirable when the dental or medical practitioner cannot readily see the display 38 to confirm that the processing component 42 will correctly modify the operational parameter of the tool 24 or the output of the pump 28 as the dental or medical practitioner desires.

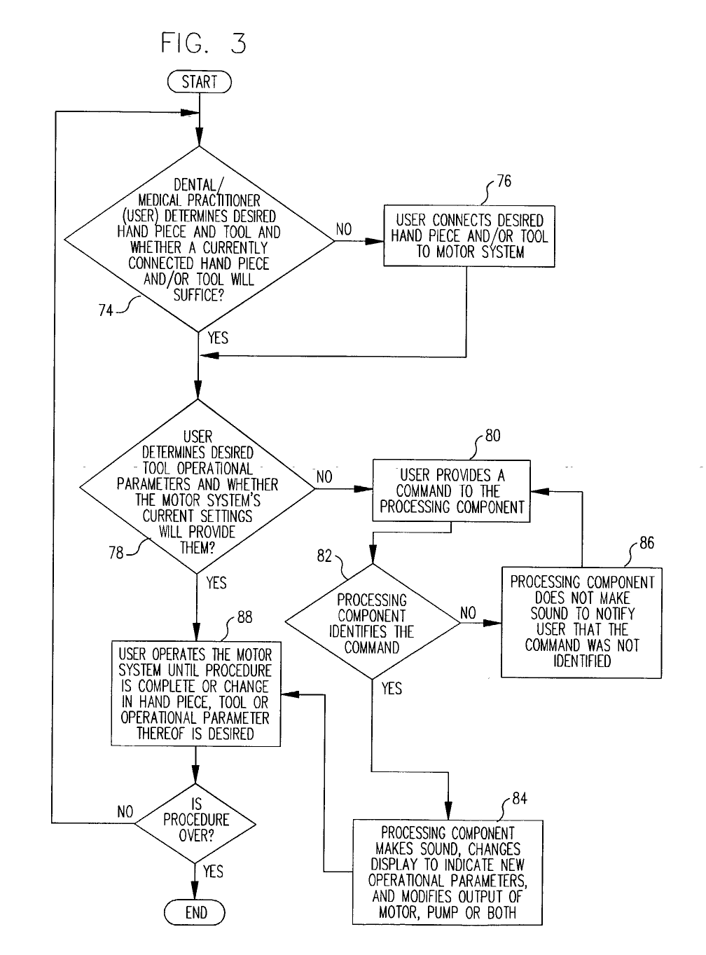

FIG. 3 is a flow chart of a process for preparing the motor system 20 in FIGS. 1 and 2 for a dental/medical procedure and operating the motor system 20 during a dental/medical procedure, according to an embodiment of the invention. First, a dental or medical practitioner selects a tool 24 (FIGS. 1 and 2) and a hand piece 22 (FIGS. 1 and 2) appropriate for the procedure to be performed at step 74. If a hand piece 22 or tool 24 are currently connected to the motor system 20, then at step 74 the dental or medical practitioner also determines whether the currently connected hand piece 22 or tool 24 are desired. If not, the dental or medical practitioner removes the currently connected hand piece 22 or tool 24 from the motor system 20 and at step 76 connects the desired hand piece 22 or tool 24 to the motor system 20.

Still referring to FIG. 3 at step 78, the dental or medical practitioner determines the desired operational parameters of the tool and whether the current output of the motor 26 (FIGS. 1 and 2) will provide the desired operational parameters to the tool 24. If not, then at step 80, the dental or medical practitioner can provide the processing component 42 a command to modify the output of the motor 26, the output of the pump 28 or both. For example, in this and certain other embodiments and as previously discussed elsewhere herein, the dental or medical practitioner can provide the command by speaking the command and the desired operational parameter for the tool 24 into the microphone 30 (FIGS. 1 and 2). Additionally or alternatively, the dental or medical practitioner can provide the command by speaking an identifier corresponding to a value of a motor-output-parameter or pump-output-parameter or by speaking an identifier corresponding to a combination of output-parameter values. Additionally or alternatively, a dental or medical practitioner can push one or more of the buttons 36 (FIGS. 1 and 2).

Still referring to FIG. 3, then at step 82, the processing component 42 can attempt to identify the command and the desired tool operational parameter and then notify the dental or medical practitioner as desired that the command and desired tool operational parameter was either identified or not. For example, in this and certain other embodiments, if the processing component 42 identifies the command and desired tool operational parameter, then at step 84 the processing component 42 can sound a “beep” through the speaker 72 (FIG. 2), can retrieve the desired value or combination of values in the memory 64 (FIG. 2) (if a corresponding identifier was spoken) and can accordingly modify the output of the motor 26, pump 28 or both. If, the processing component 42 identifies the command but not the desired tool operational parameter, then the processing component 42 can approximate the dental or medical practitioner's desired tool operational parameter to a tool operational parameter that is close, can sound a “beep” through the speaker 72 and modify the output of the motor 26, pump 28 or both. If the processing component 42 cannot identify the command, then at step 86, the processing component 42 may not sound a beep and the processing component 42 can either wait for the dental or medical practitioner to provide an identifiable command or direct the motor 26, pump 28 or both to provide the previously provided output.

Still referring to FIG. 3, at step 88 the dental or medical practitioner operates the motor system 20 until he/she has completed the dental/medical procedure, desires to change an operational parameter of the tool 24, or desires to change the hand piece 22 or tool 24. If the dental or medical practitioner wants to change an operational parameter of the tool 24, or wants to change the hand piece 22 or tool 24, then he/she returns to step 74 of the process and proceeds as discussed elsewhere herein.

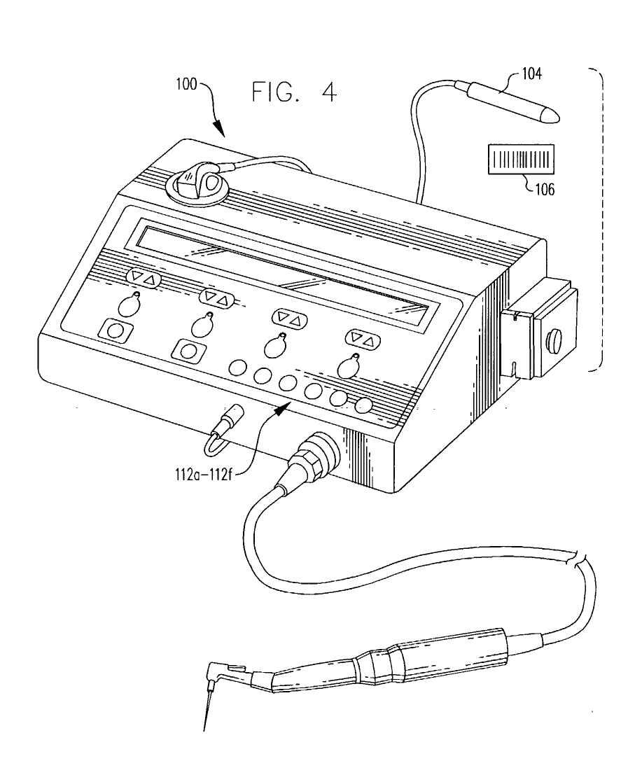

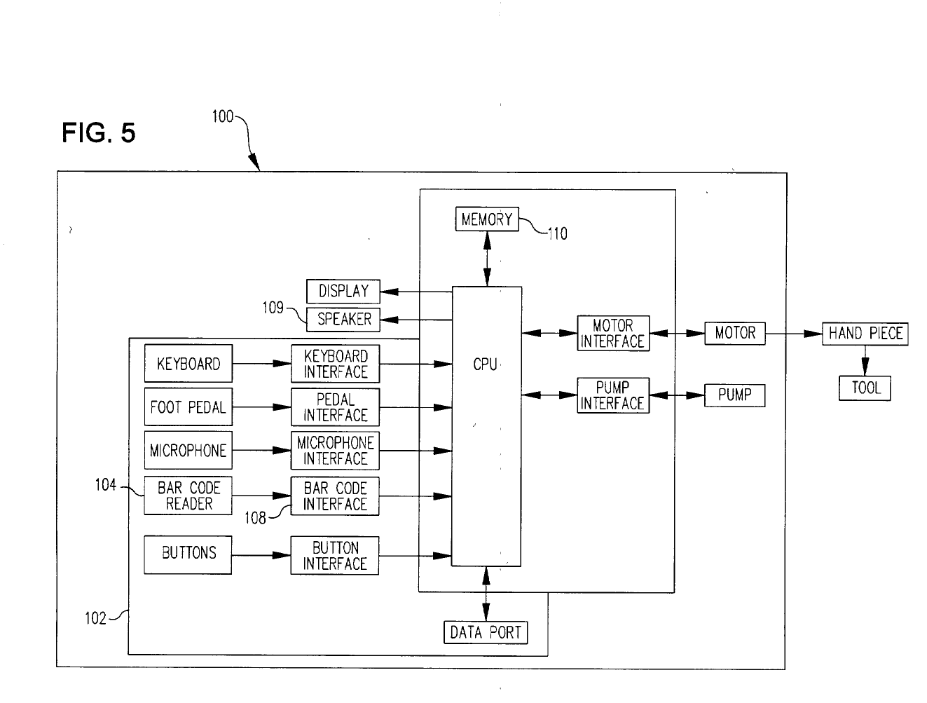

FIG. 4 is a perspective view of a motor system 100 according to another embodiment of the invention. FIG. 5 is block diagram of the motor system 100 in FIG. 4. The motor system 100 is similar to the motor system 20 (FIGS. 1 and 2) except the motor system 100 includes a data input component 102 (FIG. 5) that includes a bar code reader 104 for reading bar codes 106 (only one shown in FIG. 4) and a bar code interface 108 (FIG. 5) for converting data from the bar code 106 into digital data for the processing component 42 (FIG. 5). To notify a dental or medical practitioner whether or not the bar code reader 104 read a bar code 106, the processing component 42 can provide a sound via the speaker 109 as discussed in conjunction with the motor system 20. The bar code reader 104 can provide an additional or alternative way that a dental or medical practitioner can quickly prepare a motor system for a procedure and quickly modify an operational parameter of a tool connected to the system. Furthermore, because the bar code reader 104 and bar code 106 can be sterilized in an autoclave, sterilizing the bar code reader 104 and bar code 106 between procedures is not time consuming.

The bar code 106 can include any desired data and the bar code reader 104 can be any desired reader. For example, in this and certain other embodiments, the bar code reader 104 can be any conventional bar code reader and the bar code 106 can include a command to increase the speed motor-output-parameter of the motor's output by 50 rpms. Additionally or alternatively, the bar code 106 can include an identifier corresponding to an associated motor-output-parameter value or combination of motor-output-parameter values. Additionally or alternatively, the bar code 106 can include commands to combine motor-output-parameter values included in the motor output data stored in a memory 110 and to associate the combination with an identifier. Thus, a dental or medical practitioner can store more values or combinations of values for motor-output-parameters and pump-output-parameters than the six preset buttons 112a-112f permit. This may be desirable when the dental or medical practitioner performs many different types of procedures with the same motor system 100.

Although motor systems and methods for using them have been described in considerable detail with reference to certain embodiments for purposes of illustration, other embodiments are possible. Therefore the spirit and scope of the appended claims should not be limited to the above description of the embodiments; the present inventions include suitable modifications as well as all permutations and combinations of the subject matter set forth herein.

What is claimed is:

1. A motor system for use in dental/medical procedures, comprising:
a motor providing an output and operable to power a tool;
a data input component including a microphone operable to receive spoken audio voice data; and
a processing component operable to identify a command in the spoken audio voice data and to modify the motor's output according to the command.

2. The system of claim 1 wherein the motor's output includes at least one motor output parameter in the group consisting of speed, torque, rotational direction and torque threshold.

3. The system of claim 1 wherein the tool includes at least one tool in the group of tools consisting of a handpiece, a cutter, a grinder, a reamer, a drill and a file.

4. The system of claim 1-wherein:
the motor's output includes a speed and a torque motor output parameter; and
the processing component includes a memory for storing motor output data that includes at least one value for the speed and the torque motor output parameters, and a corresponding identifier associated with each value.

5. The system of claim 4 wherein:
the motor output data includes at least one combination of values for different motor output parameters; and
a corresponding identifier is associated with each combination of values.

6. The system of claim 1 wherein a first aural sound sounds when the processing component identifies a command in the spoken audio voice data.

7. The system of claim 6 wherein the aural sound includes a beep.

8. The system of claim 1 wherein the data input component includes at least one button operable to modify the motor's output.

9. The system of claim 8 wherein:
the processing component includes a memory for storing motor output data that includes at least one value for a parameter of the motor's output; and
the at least one button includes at least one preset button operable to select a motor-output-parameter value.

10. The system of claim 9 wherein the at least one button also includes at least one of the group of buttons consisting of:
two ratio buttons operable to provide the processing component the output ratio of a handpiece,
a speed button operable to increase a rotational speed of the motor,
another speed button operable to decrease a rotational speed of the motor,
a forward/reverse button operable to select a rotational direction of the motor,
a torque button operable to increase a torque output of the motor,
another torque button operable to decrease a torque output of the motor, and
a max button operable to select a threshold torque output of the motor.

11. The system of claim 1 wherein the data input component includes a data port for providing the processing component at least one of the group consisting of data and software.

12. The system of claim 1 wherein:
the data input component includes a bar code reader operable to read a bar code; and
the processing component is operable to modify the motor's output according to bar code data generated from the bar code.

13. The system of claim 12 wherein a first aural sound sounds when the bar code reader reads the bar code.

14. The system of claim 13 wherein the aural sound includes a beep.

15. The system of claim 1 further comprising a pump providing a pump output and operable to move irrigating fluid, and wherein the processing component is operable to modify the pump's output according to the command.

16. The system of claim 15 wherein the pump output includes a flow rate.

17. The system of claim 15 wherein;
the processing component includes a memory for storing motor output data that includes at least one value for a parameter of the motor's output, and pump output data that includes at least one value for a parameter of the pump's output; and
at least one combination of a motor output-parameter value and a pump output-parameter value is associated with a corresponding identifier.

18. The system of claim 17 wherein the data input component includes at least one preset button operable to select a combination of a motor output-parameter value and a pump output-parameter value.

19. The system of claim 15 wherein:
the data input component includes at least one button operable to modify the output of the pump; and
the at least one button includes at least one of the group of buttons consisting of:
a pump button operable to increase a flow rate of the pump,
another pump button operable to decrease a flow rate of the pump, and
a pump on/off button operable to turn a pump on and off.

20. A method for modifying an operational parameter of a tool connected to a motor system for performing-dental/medical procedures, comprising:
a data input component receiving spoken audio voice data;
a processing component identifying a command in the spoken audio voice data; and
the processing component modifying an output of a motor operable to power the tool according to the command.

21. The method of claim 20 further comprising:
storing in a memory motor output data that includes at least one value for a motor output parameter; and
wherein modifying a motor's output includes:
retrieving a value for a motor output parameter stored in the memory.

22. The method of claim 21 wherein:
storing motor output data in a memory includes storing at least one combination of values for different motor output parameters and associating each combination with a corresponding identifier;
identifying commands in the spoken audio voice data includes identifying an identifier; and
retrieving a value for a motor output parameter stored in the memory includes retrieving a combination of values corresponding to the identifier identified.

23. The method of claim 20 wherein modifying an output of a motor includes at least one of the group consisting of:
notifying the processing component of the output ratio of a handpiece,
increasing a rotational speed of the motor,
decreasing a rotational speed of the motor,
selecting a rotational direction of the motor,
increasing a torque output of the motor,
decreasing a torque output of the motor, and
selecting a threshold torque output of the motor.

24. The method of claim 20 further comprising the processing component modifying an output of a pump operable to move irrigating fluid, according to the command.

25. The method of claim 24 wherein modifying an output of a pump includes at least one of the group consisting of:
increasing a flow rate of the pump,
decreasing a flow rate of the pump, and
turning the pump on or off.

26. A motor system for use in dental/medical procedures, comprising:
a means for providing spoken audio voice data to a means for processing the data;
a means for processing the data including a means for identifying commands in the spoken audio voice data; and
a means for modifying an output of a motor operable to power a tool.

27. The system of claim 24 further comprising a means for modifying an output of a pump operable to move irrigating fluid.
